(19) United States
(12) Patent Application Publication
(10) Pub. No.: US 2010/0094810 A1
(43) Pub. Date: Apr. 15, 2010

(54) Information processing apparatus, process control method, and computer program product

(75) Inventor: Yuki Ishibashi, Kanagawa (JP)

Correspondence Address: HARNESS, DICKEY & PIERCE, P.L.C., P.O. BOX 8910, RESTON, VA, 20195, US

(73) Assignee: RICOH COMPANY, LTD.,

(21) Appl. No.: 12/585,375

(22) Filed: Sep. 14, 2009

(30) Foreign Application Priority Data
Sep. 17, 2008 (JP) 2008-238116

(51) Int. Cl. G06F 12/00

(52) U.S. Cl. 707/662

(57) ABSTRACT

A storage unit stores flow definition data defining process flow of at least one process for data input from a data input apparatus. A communication unit controls transmission/reception of data between the data input apparatus and an arbitrary apparatus connected via a network. A flow-execution control unit controls execution of the at least one process based on the flow definition data. A flow-definition-data control unit defines an upload mode to avoid a data overwrite when a file of an identical name exists upon uploading the data to the arbitrary apparatus, sets the upload mode in the flow definition data, and stores it in the storage unit.

### CROSS-REFERENCE TO RELATED APPLICATIONS

The present application claims priority to and incorporates by reference the entire contents of Japanese Patent Application No. 2008-238116 filed in Japan on Sep. 17, 2008.

### BACKGROUND OF THE INVENTION

1. Field of the Invention

The present invention relates to an information processing apparatus that controls processing involved in data uploading, a process control method, and a computer program product.

2. Description of the Related Art

In recent years, a large number of enterprises are networking their data input/output (I/O) devices, such as multifunctional products (MFPs). The data I/O devices play key roles in increasing operating effectiveness. A focus is in particular placed on a distribution management system that enables efficient conversion of a paper document into electronic form and distribution of the converted document. Key elements of the distribution management system are an image input apparatus (scanner) and a distributing apparatus, such as a distribution management server, that performs distribution processing. A plurality of distribution processing menus for making selection of an appropriate service and/or operation is stored in the distribution apparatus in advance. Examples of conventional techniques related to such a system will be mentioned below.

Japanese Patent Application Laid-open No. 2008-97586 discloses an information processing apparatus that facilitates processing control on image data. To perform processing on image data, a distribution server transmits a screen definition data to an MFP. Upon receipt of the screen definition data, the MFP displays a metadata entry screen based on the screen definition data to receive entry of metadata and transmits the metadata to the definition server. The definition server relates the metadata fed from the definition server to flow definition data, and then controls processing on scanned image data according to the flow definition data to which the metadata is related.

Japanese Patent Application Laid-open No. 2006-323783 discloses a highly convenient file management technique for an information processing apparatus that receives a target file, stores therein the target file, and manages the target file. In this technique, the information processing apparatus generates an identifier for the target file and stores therein the target file under a file name based on the identifier. The information processing apparatus holds file information (file identification (ID), original file name, and locations where file is to be stored). When a file (hereinafter, “same-name file”) whose file name is the same with a file name of the target file has already been registered in the file information, the information processing apparatus determines whether to update the same-name file or stores the target file under another file name. When it is determined to update the same-name file, the information processing apparatus deletes, from the file information, a portion of the file information corresponding to the same-name file and deletes the same-name file.

Japanese Patent Application Laid-open No. 2006-350829 discloses a file-version control apparatus that stores therein history data in a remote access environment or the like. The file-version control apparatus that includes a file-access verifying unit, a user-data managing unit, a version control unit, and a setting-data managing unit acquires a response packet that is issued in response to a request packet. The file-access verifying unit extracts a processing request and a reply to the request from the response packet, and determines whether the extracted data matches an access pattern corresponding to a data update operation by comparing the extracted data against the access pattern. The user-data managing unit manages user data to identify which user has issued the processing request in the request packet. When the file-access verifying unit has determined that the extracted data has matched the access pattern corresponding to the data update operation to be performed by using application software, the version control unit controls generation of data for use in version control. The setting-data managing unit holds operation setting data that is necessary to perform file access verification, user data management, and version control. A command context about file access is analyzed to determine whether the command context matches a predetermined pattern according to which the data for use in version control of the file is to be generated. When the command context is determined to match the predetermined pattern, the data for use in version control of the file is generated.

Japanese Patent Application Laid-open No. 2006-209662 discloses a file managing apparatus that determines in advance whether changing a file name can result in occurrence of an error and informs a user about the possible error. The file managing apparatus creates a new file name based on a rule that has been set via a file-name setting menu, an extension-format setting menu, a basic setting menu, and a format setting menu, and displays the new file name on a new-file-name-list display window. When the new file name is invalid, the file managing apparatus displays the invalid file name in a manner distinguishable from other file names to notify the user about the invalid file name. The file managing apparatus renames a file that is stored in a storage medium. The file managing apparatus selects a file that is specified as a renaming target file among files stored in the storage medium, and prompts a user to set a renaming rule under which a new file name is to be created. The file managing apparatus creates a new file name according to the renaming rule, and renames the target file to the new file name. When a plurality of files have file names that are the same except of their extensions, the file managing apparatus creates new file names for the files having the same name except of their extensions.

However, when uploading of image data acquired by an image forming apparatus, e.g., a scanner, to a database has failed due to some reason, this failure can result in data lost and cause an inconvenience to a user, which is a great problem. To avoid such an inconvenience, typically notification about the problem has conventionally been performed by logging or transmitting an electronic mail (e-mail) of an error report to a system administrator. This notification permits a user and/or a system administrator to recognize immediately that data lost can occur. However, when a same-name file whose file name is same with a file name a data file to be uploaded has already been stored in the database, the same-name file can be overwritten unintentionally while no error is recorded or notified. Hence, in such a case, data lost cannot be prevented, which is a problem.

In particular, in the technique disclosed in Japanese Patent Application Laid-open No. 2006-323783, when the same-name file has already been stored, the file is updated or stored under another file name. However, the same-name file is deleted when it is determined that the same-name file is to be updated, which can result in data lost. When a user controls operation by using a personal computer (PC), the user can control the operation across a detailed user interface (UI). However, it is difficult to run such a detailed UI on an input apparatus, such as a scanner. Accordingly, an upload mode in which unintended overwriting can be prevented without using the detailed UI has been demanded. According to the technique disclosed in Japanese Patent Application Laid-open No. 2006-209662, the file that has already been stored is renamed. Accordingly, this technique is disadvantageous in not capable of renaming a file in advance before the file is uploaded.

### SUMMARY OF THE INVENTION

It is an object of the present invention to at least partially solve the problems in the conventional technology.

According to one aspect of the present invention, there is provided an information processing apparatus including a storage unit that is connected to a network and stores therein flow definition data defining process flow of at least one process for data input from a data input apparatus; a communication unit that controls transmission and reception of data between the data input apparatus and an arbitrary apparatus that is connected to the network; a flow-execution control unit that controls execution of the at least one process for the data based on the flow definition data; and a flow-definition-data control unit that defines an upload mode for avoiding a data overwrite when a file of an identical name exists in the arbitrary apparatus upon uploading the data to the arbitrary apparatus, sets the upload mode in the flow definition data, and stores the flow definition data in the storage unit. When the file of the identical name exists in the arbitrary apparatus, the flow-execution control unit performs the at least one process according to the upload mode set in the flow definition data.

Furthermore, according to another aspect of the present invention, there is provided a method of controlling a process executed in an information processing apparatus that is connected to a data input apparatus and an arbitrary apparatus via a network. The information processing apparatus includes a storage unit that stores therein flow definition data defining process flow of at least one process for data input from the data input apparatus. The method includes communicating including a communication unit controlling transmission and reception of data between the data input apparatus and the arbitrary apparatus; flow-execution controlling including a flow-execution control unit controlling execution of the at least one process for the data based on the flow definition data; and flow-definition-data controlling including a flow-definition-data control unit defining an upload mode for avoiding a data overwrite when a file of an identical name exists in the arbitrary apparatus upon uploading the data to the arbitrary apparatus, setting the upload mode in the flow definition data, and storing the flow definition data in the storage unit. When the file of the identical name exists in the arbitrary apparatus, the flow-execution controlling includes the flow-execution control unit performing the at least one process according to the upload mode set in the flow definition data.

Moreover, according to still another aspect of the present invention, there is provided a computer program product including a computer-usable medium having computer-readable program codes embodied in the medium for controlling a process executed in an information processing apparatus that is connected to a data input apparatus and an arbitrary apparatus via a network. The information processing apparatus includes a storage unit that stores therein flow definition data defining process flow of at least one process for data input from the data input apparatus. The program codes when executed cause a computer to executed communicating including a communication unit controlling transmission and reception of data between the data input apparatus and the arbitrary apparatus; flow-execution controlling including a flow-execution control unit controlling execution of the at least one process for the data based on the flow definition data; and flow-definition-data controlling including a flow-definition-data control unit defining an upload mode for avoiding a data overwrite when a file of an identical name exists in the arbitrary apparatus upon uploading the data to the arbitrary apparatus, setting the upload mode in the flow definition data, and storing the flow definition data in the storage unit. When the file of the identical name exists in the arbitrary apparatus, the flow-execution controlling includes the flow-execution control unit performing the at least one process according to the upload mode set in the flow definition data.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is an explanatory block diagram of a network configuration of a network distribution system according to an embodiment of the present invention;

FIG. 2 is a block diagram depicting a functional configuration of the flow definition apparatus depicted in FIG. 1;

FIG. 3 is a schematic functional diagram of an exemplary module configuration of a flow-definition generating unit of the flow definition apparatus depicted in FIG. 2;

FIG. 4 is a schematic diagram depicting a scenario of generation of flow definition data (flow name: “ScanToDBanotherName”) of Example 1 of the embodiment;

FIG. 5 is a flowchart that illustrates an exemplary procedure of the generation of flow definition data;

FIG. 6 is a flowchart that illustrates an exemplary procedure of flow execution control;

FIG. 7 is a schematic diagram depicting an exemplary module configuration for “renaming file” option;

FIG. 8 is a schematic diagram of a scenario through which a data file is input from the image forming apparatus depicted in FIG. 1 and the data file is uploaded (flow name: “ScanToFolderanotherName”);

FIG. 9 is a part of an exemplary flow definition data file (XML) in which the “renaming file” option is defined as the upload mode;

FIG. 10 is a part of an exemplary document data file (XML) that is created for the “renaming file” option;

FIG. 11 is a flowchart that illustrates an exemplary procedure for the “renaming file” option;

FIG. 12 is a schematic diagram depicting an exemplary module configuration for “creating new folder” option;

FIG. 13 is a part of an exemplary flow definition data file (XML) in which the “creating new folder” option is defined as the upload mode;

FIG. 14 is a part of an exemplary document data file (XML) that is created for the “creating new folder” option;

FIG. 15 is a flowchart that illustrates an exemplary procedure for the “creating new folder” option;

FIG. 16 is a part of an exemplary flow definition data file (XML) in which “check-out & check-in” option is defined as the upload mode;

FIG. 17 is a flowchart that illustrates an exemplary procedure for the “check-out & check-in” option;

FIG. 18 is a part of an exemplary flow definition data file (XML) for the “check-out & check-in” option;

FIG. 19 is a part of another exemplary document data file (XML) for the “check-out & check-in” option;

FIG. 20 is a part of another exemplary module configuration for the “check-out & check-in” option defined for the upload mode;

FIG. 21 is a flowchart that illustrates an exemplary procedure for the “bind” option;

FIG. 22 is a part of an exemplary flow definition data file (XML) in which the “bind” option is defined;

FIG. 23 is a part of an exemplary document data file (XML) in which “destination-not-specified” option is defined as the upload mode;

FIG. 24 is a schematic diagram depicting an exemplary module configuration for the “destination-not-specified option” option; and

FIG. 25 is a flowchart that illustrates an exemplary procedure for the “destination-not-specified” option.

### DETAILED DESCRIPTION OF THE PREFERRED EMBODIMENTS

Exemplary embodiments of the present invention are described in detail below with reference to the accompanying drawings. More specifically, a flow definition apparatus, an image forming apparatus, and a server apparatus each of which is an example an information processing apparatus, a data input apparatus, and a target apparatus to which data is to be uploaded according to an embodiment of the present invention, respectively, are described below. The flow definition apparatus distributes data, such as image data that is acquired by a scanner, a multifunction product (MFP), or the like by scanning. Note that a method, an apparatus, and a computer program product for information processing and a recording medium that stores therein the computer program according to the present invention are not limited to the embodiments, and can be applied to any apparatus and system that controls data processing.

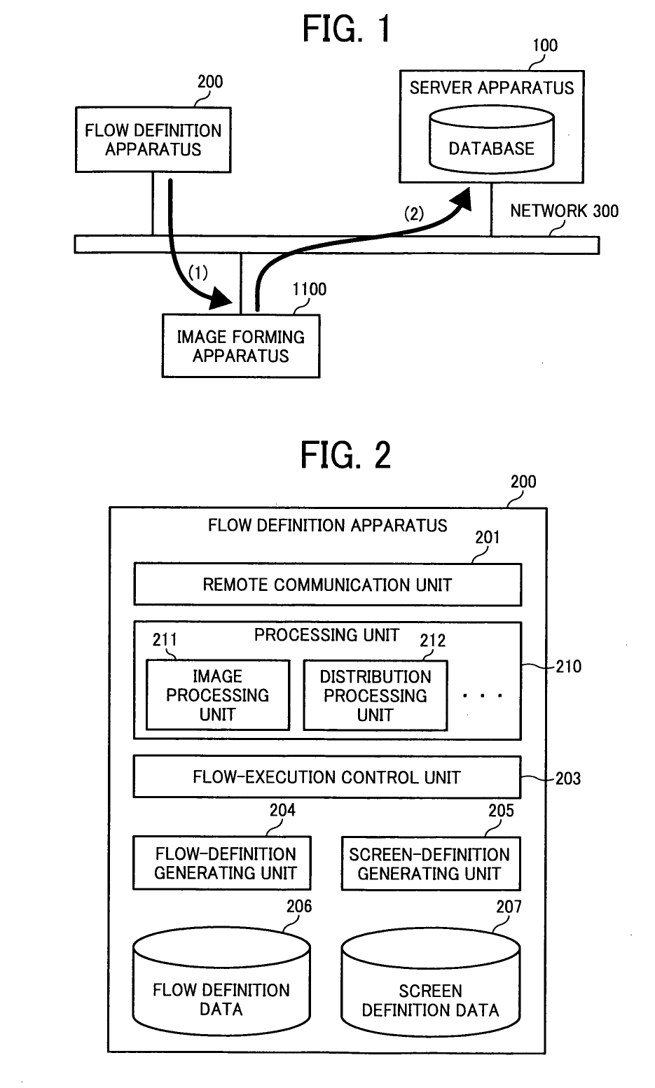

FIG. 1 is an explanatory block diagram of a network configuration of a network distribution system according to the embodiment of the present invention. The network distribution system according to the embodiment includes a flow definition apparatus 200, an image forming apparatus 1100, and a server apparatus 100 that are connected to a network 300, such as a local area network (LAN) or the Internet. Briefly, the network distribution system such that: (1) the flow definition apparatus 200 transmits flow definition data to the image forming apparatus 1100; and (2) upon receipt of the flow definition data, the image forming apparatus 1100 processes image data or the like in an upload mode that is defined by the flow definition data, and transmits the image data or the like to the server apparatus 100.

The image forming apparatus 1100 provides functions of a scanner and the like. The image forming apparatus 1100 can be an MFP that has, in addition to the function as a scanner, a copying machine, a printer, and/or a facsimile machine packaged in a single enclosure. The image forming apparatus 1100 acquires, for example, image data or the like (hereinafter, “image data”) by scanning a paper medium or the like, and transmits the image data to the flow definition apparatus 200. The image forming apparatus 1100 will be described in detail later.

The flow definition apparatus 200 is a computer, such as a workstation, that receives the image data from the image forming apparatus 1100 and processes and distributes the image data in various manners according the flow definition data, which will be described later. Alternatively, the flow definition apparatus 200 can receive the image data from the image forming apparatus 1100, process the image data according to the flow definition data, and transmit the processed image data to the server apparatus 100. Further alternatively, the flow definition apparatus 200 can transmit the flow definition data to the image forming apparatus 1100 so that the image forming apparatus 1100 processes the image data according to the flow definition data and directly transmits the processed image data to the server apparatus 100.

The server apparatus 100 is a server apparatus, such as a file server, an enterprise document management system (EDMS), or a simple mail transfer protocol (SMTP) server, that is connected to the network 300. The server apparatus 100 includes a database for storing data therein. For example, a file server is a computer that accumulates and manages files to be shared over the Internet. The EDMS is what is called a document management system. The SMTP server is a server for sending e-mails according to the SMTP, which is a protocol to be used to transmit e-mails. The flow definition apparatus 200 performs distribution for access to any one of the file server, the EDMS, and the SMTP server.

The flow definition apparatus 200 will be described in detail below. FIG. 2 is a block diagram depicting a functional configuration of the flow definition apparatus 200. The flow definition apparatus 200 includes a remote communication unit 201, a processing unit 210, a flow-execution control unit 203, a flow-definition generating unit 204, a screen-definition generating unit 205, flow definition data 206, and screen definition data 207.

The flow definition data 206 is data that defines a control flow for various processing tasks (input processing, intermediate processing, distributing processing, and the like) to be performed on the image data acquired by scanning performed by and fed from the image forming apparatus 1100. The flow definition data 206 is, for example, parameter setting data that sets various parameters for the input processing, the intermediate processing, the distributing processing, and the like. The screen definition data 207 defines an upload-mode input screen. The upload-mode input screen is displayed on a display unit of the flow definition apparatus 200 or the image forming apparatus 1100 to receive a setting parameter for an upload mode and the like for the image data. The screen definition data 207 is related to the flow definition data that sets the upload mode, which is necessary for the control flow. The flow definition data 206 and the screen definition data 207 are stored in a recording medium (a first storage unit, a second storage unit) such as a hard disk drive (HDD). The flow definition data 206 and the screen definition data 207 will be described in detail later.

The remote communication unit 201 controls transmission of the screen definition data 207 to the image forming apparatus 1100. The remote communication unit 201 can also control transmission of a request for the screen definition data 207, reception of the image data and a setting parameter for an upload mode from the image forming apparatus 1100, and transmission of the screen definition data 207 to the image forming apparatus 1100. The remote communication unit 201 controls transmission and reception of various data involved in various processing.

The processing unit 210 performs various processing defined in the flow definition data 206. The processing unit 210 includes an image processing unit 211 and a distribution processing unit 212. The image processing unit 211 performs image processing such as conversion of image data. The distribution processing unit 212 distributes image data to the server apparatus 100, the image forming apparatus 1100, or the like.

The flow-execution control unit 203 reads the flow definition data 206 from the recording medium and controls various processing that is defined in the flow definition data 206 and performed by the processing unit 210. The flow-execution control unit 203 writes the setting parameter for the upload mode, which is fed from the image forming apparatus 1100 via the remote communication unit 201, in the flow definition data 206, thereby relating the setting parameter for the upload mode to the flow definition data 206. The flow-execution control unit 203 then controls various processing on the image data based on the flow definition data 206 to which the setting parameter for the upload mode is related.

The flow-definition generating unit 204 generates or edits the flow definition data 206 according to an instruction entered by a system administrator or the like of the flow definition apparatus 200, and stores the generated-or-edited flow definition data 206 in the recording medium. In the present embodiment, the flow-definition generating unit 204 includes a flow-definition-data control unit 225. The flow-definition-data control unit 225 defines the upload mode that permits, even when a file (hereinafter, “same-name file”) whose file name is the same with a file name of image data to be uploaded to the server apparatus 100 has already been stored in the server apparatus 100, the same-name file is protected from being unintentionally overwritten by uploading of the image data, writes a setting parameter for the upload mode in the flow definition data 206, and stores the flow definition data 206 in the recording medium.

In the present embodiment, the term “flow” or “control flow” denotes a sequence of one or a plurality of operations to be performed on image data that is scanned by the image forming apparatus 1100. The sequence include the input processing, in which the image data is input to the flow definition apparatus 200 from the image forming apparatus 1100, the output (distributing) processing, in which the image data is distributed, and the intermediate processing that is downstream of the input processing and upstream of the output processing. The flow definition data 206 describes a sequence of at least one input processing task, at least one intermediate processing task, and at least one output processing task. Examples of the controls flow described in the flow definition data 206 include a control flow for performing the intermediate processing, such as image conversion of scanned image data of a document, and distribution (output) of the converted image data to a folder sequentially, and a control flow for transmitting scanned image data via e-mail. The flow definition data 206 can describe only a part of the input processing, the intermediate processing, and the output processing. Alternatively, the flow definition data 206 can be defined such that a sequence of processing tasks is performed simultaneously.

Examples of the output processing include distribution of image data to a folder in the image forming apparatus 1100, in a desired personal computer (PC) on the network 300, or in the server apparatus 100 such as a file server or a Web server, and transmission of image data as an attachment to e-mail by utilizing the SMTP server. Examples of the intermediate processing include conversion of image data to image data of a predetermined format. The flow definition data 206 of the present embodiment is described, for example, in eXtensible Markup Language (XML).

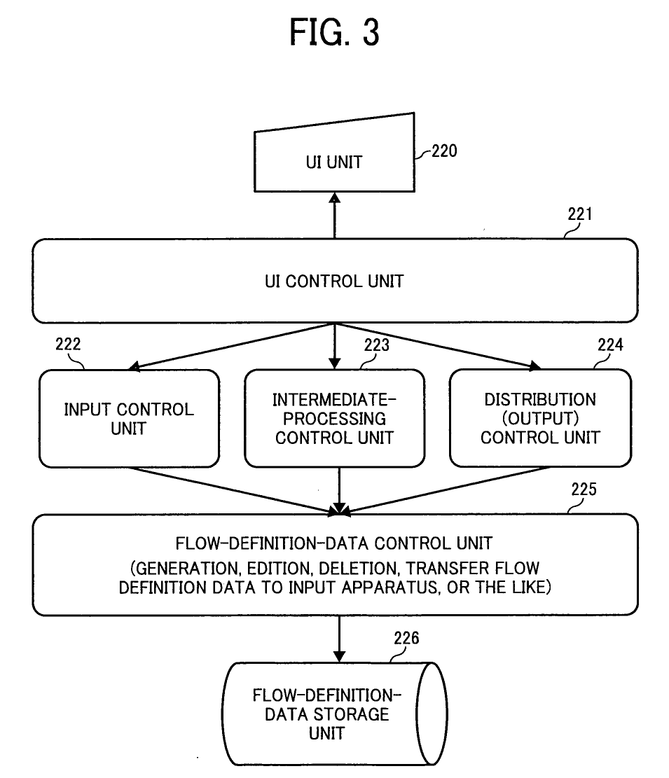

A module configuration of the flow-definition generating unit 204 for creating the flow definition data 206 will be described below. FIG. 3 is a schematic functional diagram depicting an exemplary module configuration of the flow-definition generating unit 204. The flow-definition generating unit 204 includes a user interface (UI) unit 220, a UI control unit 221, an input control unit 222, an intermediate-processing control unit 223, a distribution (output) control unit 224, the flow-definition-data control unit 225, and a flow-definition-data storage unit 226. The UI control unit 221 controls the UI unit 220. The input control unit 222 defines a control flow of input processing to which image data is to be subjected. The intermediate-processing control unit 223 defines a control flow of intermediate processing to which the image data is to be subjected. The distribution (output) control unit 224 defines a control flow of distributing (output) processing to which the image data is to be subjected. The flow-definition-data control unit 225 stores the flow definition data 206 in the flow-definition-data storage unit 226. Arrows depicted in FIG. 3 indicate exemplary relationships between controlling and controlled elements; however, relationship between controlling and controlled elements, direction of connections, directions of data transmission and reception are not limited to those indicated by the arrows in FIG. 3. The same applies to any other arrow in the other drawings.

The UI unit 220 is an input unit, e.g., a keyboard, a mouse, or a pointing device such as a touch pen. The UI control unit 221 controls operator-related operations. For example, the UI control unit 221 receives an input signal entered via the UI unit 220 and displays an operation status related to entry via the UI unit 220 on a display device such as a monitor device.

The flow-definition generating unit 204 causes the UI control unit 221 to display a flow-definition-data generating screen on a display device (not shown). A system administrator, or an operator, enters data via the flow-definition-data generating screen to define a control flow in the flow definition data 206. The flow-definition generating unit 204 generates the flow definition data 206 written in XML based on the data entered by the system administrator via the flow-definition-data generating screen.

For example, a list of buttons for the input processing, the intermediate processing, and the output processing are displayed on the flow-definition-data generating screen. A user, or the system administrator, selects one or more buttons one by one from the list as required and enters setting via a dialog box or the like for the selected processing. This dialog box can also be used to prompt a user to enter an upload-mode-specifying input value for image data fed from the image forming apparatus 1100. More specifically, the upload-mode-specifying input value is used as a setting parameter that defines the upload mode in which the image data is to be processed.

When the user, or the system administrator, has thus defined the control flow via the flow-definition-data generating screen and instructs to perform the processing, the flow-definition generating unit 204 acquires the settings entered via the dialog boxes. The flow-definition generating unit 204 determines a processing identification (ID) corresponding to the processing assigned to each button, and merges the settings entered via the dialog boxes while taking orders of the processing tasks into consideration. The flow-definition generating unit 204 performs definition of tags for an XML file and the like and converts the merged content into an XML file by utilizing the tags, thereby generating the flow definition data 206 written in XML. The flow-definition generating unit 204 stores the thus-generated flow definition data 206 in the storage unit (the flow-definition-data storage unit 226), which is an HDD or the like.

The screen-definition generating unit 205 generates or edits the screen definition data 207 according to an instruction entered by the system administrator, or the user, and stores the generated-or-edited screen definition data 207 in the recording medium.

The screen definition data 207 is data that defines the upload-mode input screen that is displayed to prompt a user to enter the upload-mode-specifying input value. The upload-mode-specifying input value is necessary for the sequence of processing tasks defined in the flow definition data 206. In the present embodiment, the screen definition data 207 is described in, for example, in XML. For example, the screen definition data 207 defines the upload-mode input screen that is to be displayed to prompt a user to enter an upload-mode-specifying input value. The upload-mode-specifying input value is to be written in the flow definition data 206.

The screen definition data 207 contains various tags such as <ID> and <Items>. The tag <ID> is a descriptor used to set a definition data ID for identification of the screen definition data 207. The tag <Items> is a descriptor used to set an input field, a name to be displayed (hereinafter, “display name”) of the input field, a field input condition, or the like. The tag <Items> is used to prompt a user to enter an upload-mode-specifying input value via the upload-mode input screen that is generated based on the screen definition data. Examples of the display name for the upload mode include “renaming file”, “creating new folder”, “check-out & check-in”, “bind”, and “destination-not-specified”. The upload-mode-specifying input value can be entered by prompting the user to select a tab among tabs or pressing a radio button among radio buttons that are provided for selection of the upload mode. The screen definition data 207 can be transmitted from the flow definition apparatus 200 to the server apparatus 100 as follows. When a user starts scanning by using the image forming apparatus 1100, the image forming apparatus 1100 transmits a request for screen definition data to the flow definition apparatus 200. In response to the request, the flow definition apparatus 200 transmits the screen definition data 207 associated with a control flow for the distribution processing to be performed to the image forming apparatus 1100.

The image forming apparatus 1100 will be described in detail below. The image forming apparatus 1100 according to the present embodiment primarily includes scanner application software, a control unit, a remote communication unit, a display control unit, an input control unit, an operation panel, a scanner engine, and server information.

The server information is a database in which an internet protocol (IP) address and the like of the server apparatus 100, the flow definition apparatus 200, or the like, are registered. The server information is stored in a storage medium, such as an HDD and a memory. The scanner engine is hardware that performs scanning. The operation panel is hardware on which various screens is displayed and via which a user can perform input operation. The operation panel includes a display unit, on which various screen can be displayed, and operation units, such as a start button, a stop button, a copy button, and a scan button.

The control unit receives a request from application software, such as the scanner application software, and controls the scanner engine, the HDD, a memory, and the like. The control unit can include a flow-execution control unit. Because the function and operation of the flow-execution control unit is similar to those of the flow-execution control unit 203 of the flow definition apparatus 200, repeated description is omitted.

The remote communication unit controls reception and transmission of various data to and from the server apparatus 100, the flow definition apparatus 200, and the like. More specifically, the remote communication unit transmits a request for a flow selecting screen, a flow ID of the selected control flow, a request for the screen definition data 207 that defines the upload-mode input screen, and scanned image data to the server apparatus 100 at the IP address registered in the server information, or the like. The remote communication unit also receives the flow selecting screen and the screen definition data 207 that defines the upload-mode input screen corresponding to the selected control flow from the flow definition apparatus 200. The remote communication unit transmits the upload-mode-specifying input value, which is entered via the upload-mode input screen displayed based on the thus-received screen definition data 207, to the flow definition apparatus 200.

The display control unit performs control so that each of various screens, a software keyboard screen, and the like are displayed on the display unit as a touch screen. More specifically, the display control unit performs processing according to the screen definition data 207, which is written in XML and received by the remote communication unit, to display the upload-mode input screen on the display unit. The input control unit receives an input entered via the touch screen or the software keyboard on the display unit or the operation unit and performs control related to the input. More specifically, when an input event, such as a touch input on the display unit or pressing one of the buttons on the operation unit, occurs, the input control unit detects that the touch input or the button pressing has been made. The input control unit sends the detection result to the scanner application software. The input control unit also receives the upload-mode-specifying input value entered via the upload-mode input screen and converts the input value into XML data.

The scanner application software is used to set parameters for scanning or perform scanning according to an instruction entered by a user via the operation unit (the scan button or the like). More specifically, the scanner application software issues a scanning request to the control unit, thereby causing the scanner engine to scan a document. The scanner application software inputs the scanned image data of the document to the flow definition apparatus 200. When scanning is started; i.e., when the input control unit has detected that the scan button has been pressed by the user, the scanner application software demands the remote communication unit to transmit a request for the flow selecting screen so that a control flow for distribution processing is selected by the user. The scanner application software also instructs the remote communication unit to transmit a request for the screen definition data to the flow definition apparatus 200 so that the upload-mode input screen is displayed on the display unit of the operation panel. In place of or in addition to the scanner application software, printing application software that performs printing, copying application software that performs copying, or facsimile application software that performs facsimile transmission and reception can be provided.

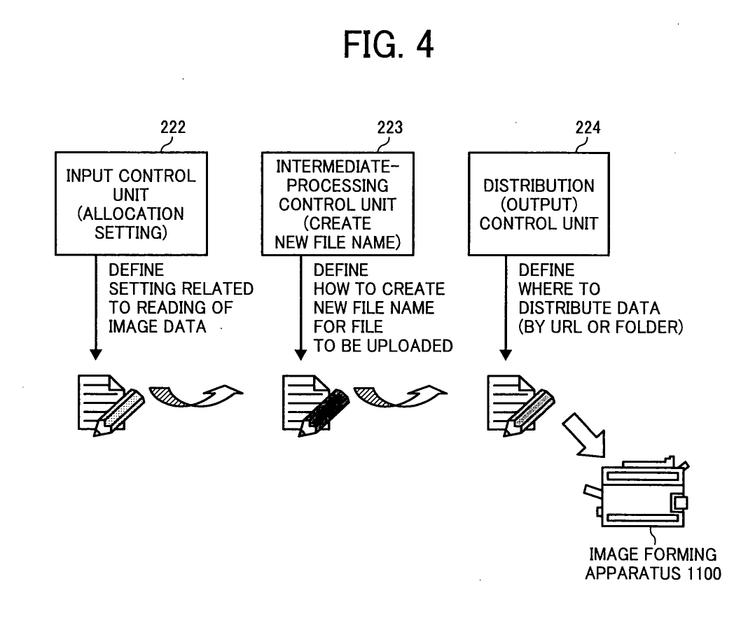

How image data is distributed by the network distribution system according to the embodiment will be described below with reference to FIGS. 4 to 25.

Exemplary processing according to Example 1 to which the present embodiment is applied will be described with reference to FIGS. 4 to 15. In the processing of Example 1, image data if input to the flow definition apparatus 200 from the image forming apparatus 1100, such as a scanner, and uploaded to a desired folder in the server apparatus 100 or the like.

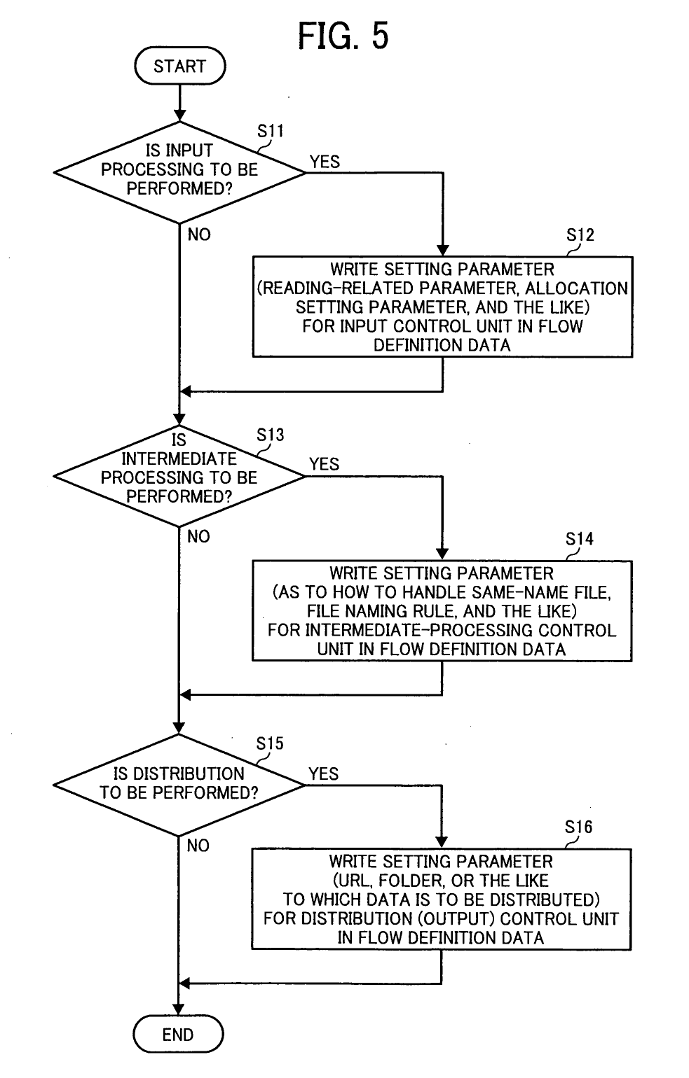

Generation of the flow definition data 206 according to the processing of Example 1 will now be described. FIG. 4 is a schematic diagram depicting a scenario of the generation of the flow definition data 206 (flow name: “ScanToDBanotherName”) according to Example 1. The scenario involves the UI control unit 221, the input control unit 222, the intermediate-processing control unit 223, the distribution (output) control unit 224, and the flow-definition-data control unit 225 of the module configuration depicted in FIG. 3. FIG. 5 is a flowchart that illustrates an exemplary procedure for the generation of the flow definition data 206.

As depicted in FIG. 3, the UI control unit 221 controls the UI unit 220 to prompt an operator, or a user, to enter setting-related information to create the scenario “ScanToDBanotherName”.

As depicted in FIG. 4, the UI control unit 221 acquires the setting-related information, such as a reading-related parameter, pertaining to the image forming apparatus 1100 from the input control unit 222, and transmits the setting-related information entered by the operator to the input control unit 222.

When the setting-related information fed from the UI control unit 221 contains a setting parameter to be processed by the input control unit 222 (Yes at Step S11), the input control unit 222 writes the setting parameter, such as the reading-related parameter and an allocation setting parameter, in the flow definition data 206 via the flow-definition-data control unit 225 (Step S12).

The UI control unit 221 displays the upload-mode input screen to prompt the operator, or the user, to enter a setting parameter that defines an upload mode.

When the setting-related information contains a setting parameter to be processed by the intermediate-processing control unit 223 (Yes at Step S13), the UI control unit 221 sends the setting parameter that defines the upload mode (e.g., “create new file name”) related to the intermediate processing to the intermediate-processing control unit 223. The intermediate-processing control unit 223 writes the setting parameter in the flow definition data 206 via the flow-definition-data control unit 225 (Step S14).

The UI control unit 221 displays an UI to prompt the operator to enter setting data related to the distribution (output) processing based on the setting parameter fed from the distribution (output) control unit 224. Examples of the setting data include a uniform resource locator (URL) and data about a folder to which the image data is to be uploaded.

The UI control unit 221 transmits the setting data entered by the operator to the distribution (output) control unit 224.

When the setting-related information contains a setting parameter to be processed by the distribution (output) control unit 224 (Yes at Step S15), the distribution (output) control unit 224 writes the setting parameter in the flow definition data 206 via the flow-definition-data control unit 225 (Step S16).

In each case where the input processing is not to be performed (No at Step S11), where the intermediate processing is not to be performed (No at Step S13), and where the distribution processing is not to be performed (No at Step S15), the system control proceeds to a corresponding subsequent step. The flow definition data 206 is generated in this manner, for example.

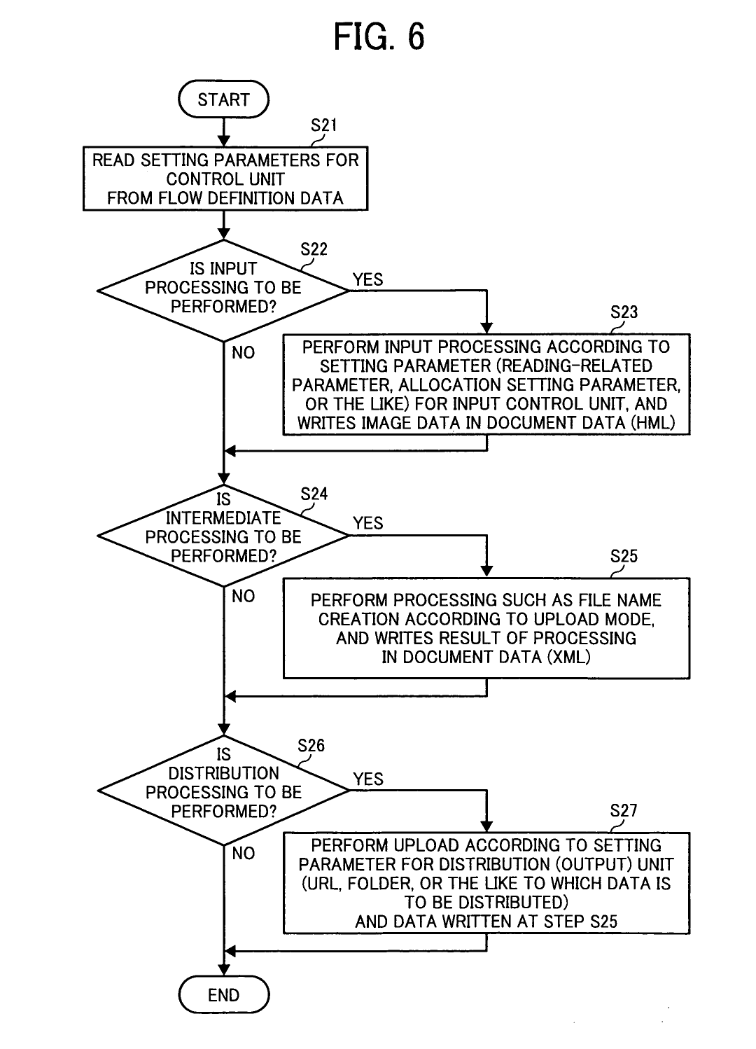

Exemplary flow execution control that is performed based on the flow definition data 206 generated in this manner will be described with reference to FIG. 6. In the flow execution control, the flow-definition-data control unit 225 reads the flow definition data 206 and performs processing based on the flow definition data 206. FIG. 6 is a flowchart that illustrates an exemplary procedure of the flow execution control. The flow-definition-data control unit 225 has control over the entire procedure.

The flow-definition-data control unit 225 reads the setting parameters for the input control unit 222, the intermediate-processing control unit 223, and the distribution (output) control unit 224 from the flow definition data 206 (Step S21).

The flow-definition-data control unit 225 determines whether the input processing is to be performed based on the flow definition data 206 (Step S22). When the input processing is to be performed (Yes at Step S22), the flow-definition-data control unit 225 reads the setting parameter, such as a reading-related parameter, to be processed by the input control unit 222, and performs the input processing according to the reading-related parameter or the like (Step S23). When the input processing is not to be performed (No at Step S22), the system control proceeds to subsequent step.

The flow-definition-data control unit 225 determines based on the flow definition data 206 whether the intermediate processing is to be performed (Step S24). When the flow definition data 206 includes a setting parameter related to the intermediate processing (e.g., upload mode) (Yes at Step S24), the flow-definition-data control unit 225 causes the intermediate-processing control unit 223 to perform the intermediate processing (Step S25). When the intermediate processing is not to be performed (No at Step S24), the system control proceeds to a subsequent step.

The flow-definition-data control unit 225 determines whether the distribution processing is to be performed based on the flow definition data 206 (Step S26). When the distribution processing is to be performed (Yes at Step S26), the flow-definition-data control unit 225 causes the distribution (output) control unit 224 to perform the distribution (output) processing (Step S27). When the distribution processing is not to be performed (No at Step S26), the system control ends.

The flow execution control is performed in this manner, for example. In the present scenario, it is assumed that image data is uploaded to a desired folder in a personal computer (PC) or the like.

(Renaming File)

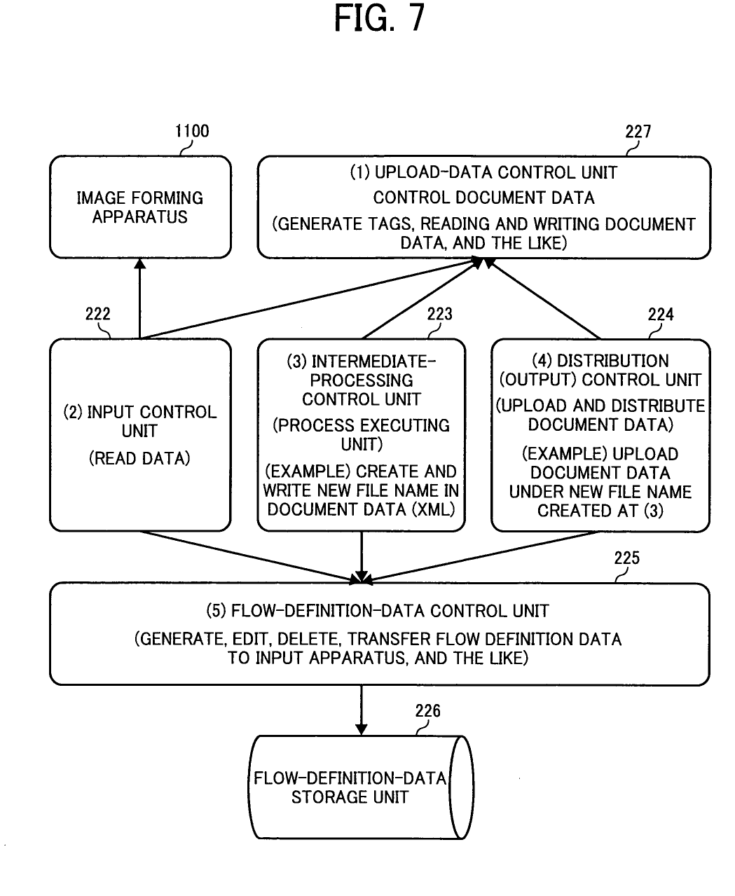

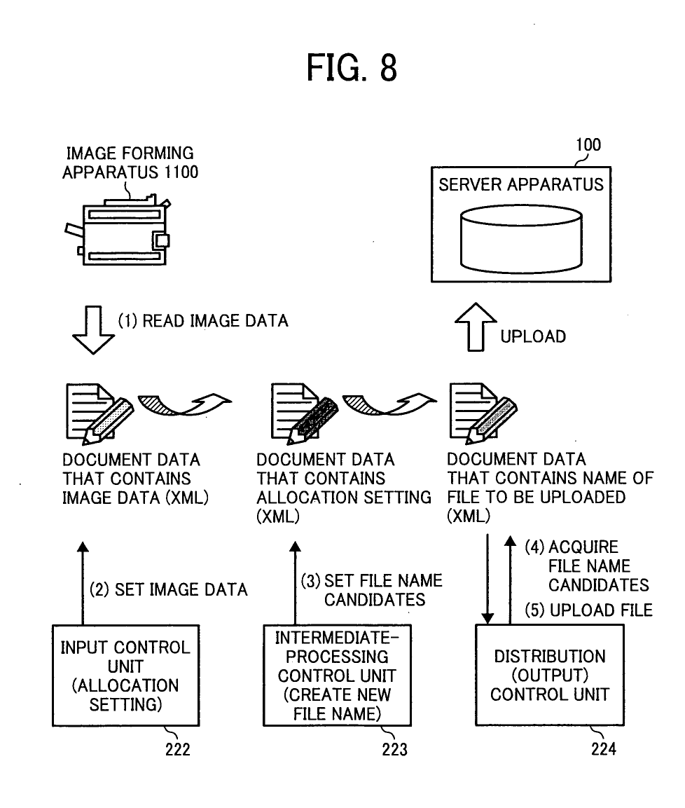

An example of the intermediate processing to be performed when “renaming file” is defined as the upload mode in the flow definition data 206 will be described with reference to FIGS. 7 to 11. FIG. 7 is a schematic diagram depicting an exemplary module configuration for the “renaming file” option. FIG. 8 is a schematic diagram depicting a scenario through which image data is input to the flow definition apparatus 200 from the image forming apparatus 1100 and uploaded to the server apparatus 100 (flow name: “ScanToFolderanotherName”). This scenario involves the input control unit 222, the intermediate-processing control unit 223, the distribution (output) control unit 224, the flow-definition-data control unit 225, and an upload-data control unit 227 of the module configuration depicted in FIG. 7.

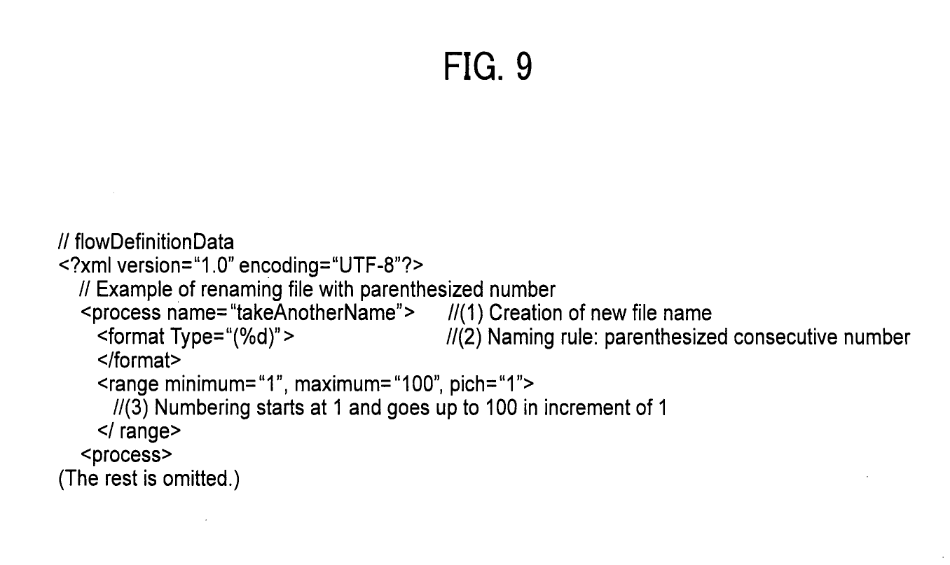

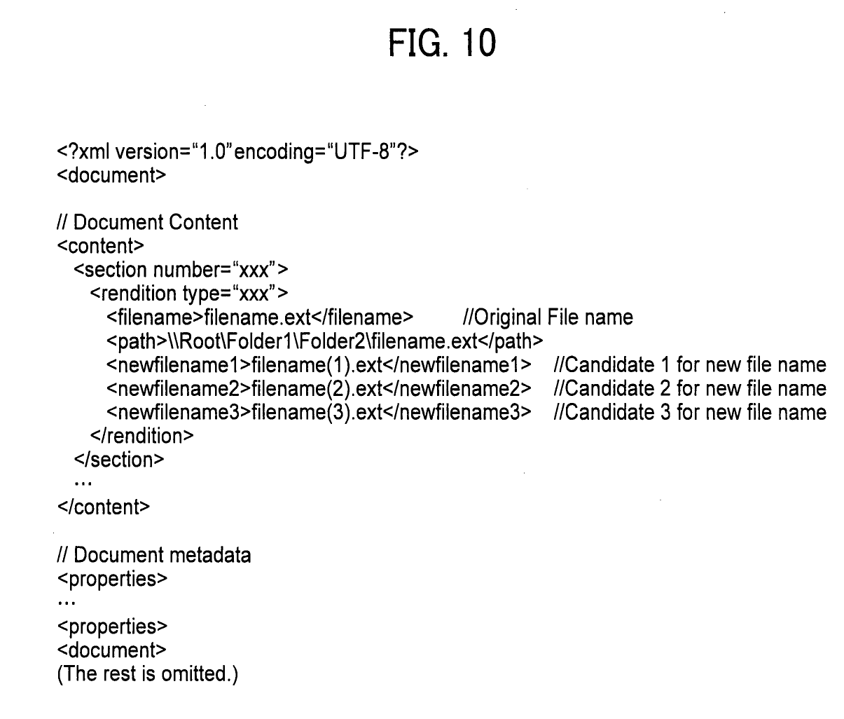

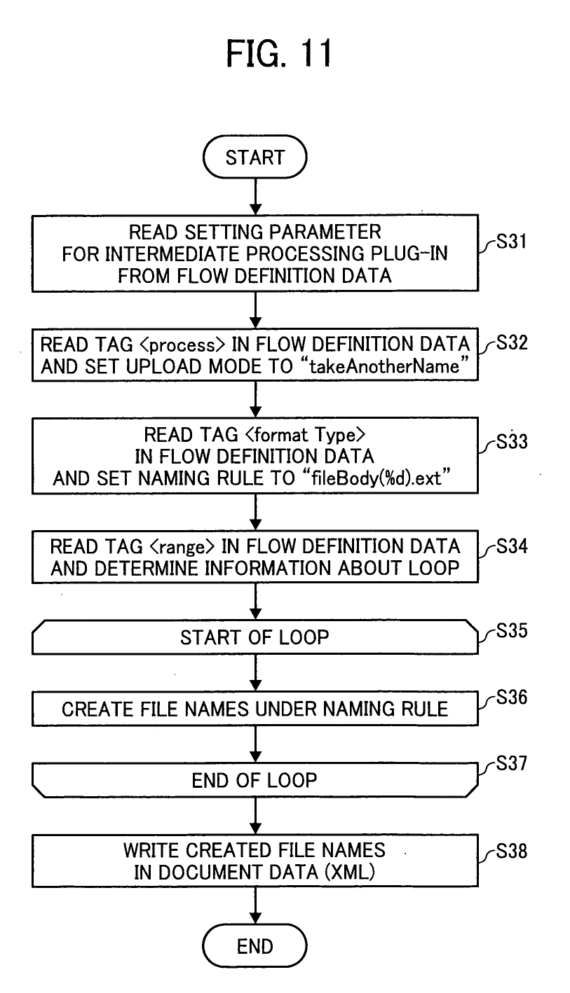

FIG. 9 is a part of an exemplary document data file (XML) in which the “renaming file” option is defined as the upload mode. FIG. 10 is a part of an exemplary document data file (XML) that is created for the “renaming file” option. FIG. 11 is a flowchart that illustrates an exemplary procedure for the “renaming file” option. The flow-definition-data control unit 225 has control over the procedure.

As depicted in FIG. 11, the flow-definition-data control unit 225 reads a setting parameter for the intermediate processing plug-in from the flow definition data 206 (Step S31). As depicted in FIG. 9, when the “renaming file” option is defined as the upload mode in the flow definition data 206, “takeAnotherName” is defined in the tag <process name>. Hence, (1) “creation of a new file name” is defined. In this upload mode, for example, “(% d)” is defined in the tag <format Type>, thereby defining (2) “naming rule: parenthesized consecutive number”. In this example, minimum=“1”, maximum=“100”, and pitch=“1” are defined in the tag <range>, thereby defining that the consecutive number starts at 1 and goes up to 100 in increment of 1.

The intermediate-processing control unit 223 takes out the tag <process> from the flow definition data 206 to acquire “takeAnotherName” as the upload mode, and recognizes that a new file name is to be created (Step S32).

The intermediate-processing control unit 223 takes out “(% d)” from the tag <format Type> (Step S33) and minimum=“1”, maximum=“100”, and pitch=“1” from the tag <range> (Step S34). The intermediate-processing control unit 223 performs the loop of Steps S35, S36, and S37, thereby creating file names “filename (1).ext”, “filename (2).ext”, . . . and “filename (100).ext” (Steps S35 to S37), and writes 100 file names in the document data via the upload-data control unit 227 (Step S38).

For example, as depicted in FIG. 10, candidates of the file name that is to be used in renaming file performed by the distribution (output) control unit 224 are written in the document data. More specifically, the distribution (output) control unit 224 acquires the candidates of the file one by one in ascending numeric order so that a file is uploaded under a unique file name. The portion of the file name indicated by “filename” is replaced with its original file name by the distribution (output) control unit 224. The intermediate processing is performed in this manner when the “renaming file” option is defined as the upload mode in the flow definition data 206.

(Creating New Folder)

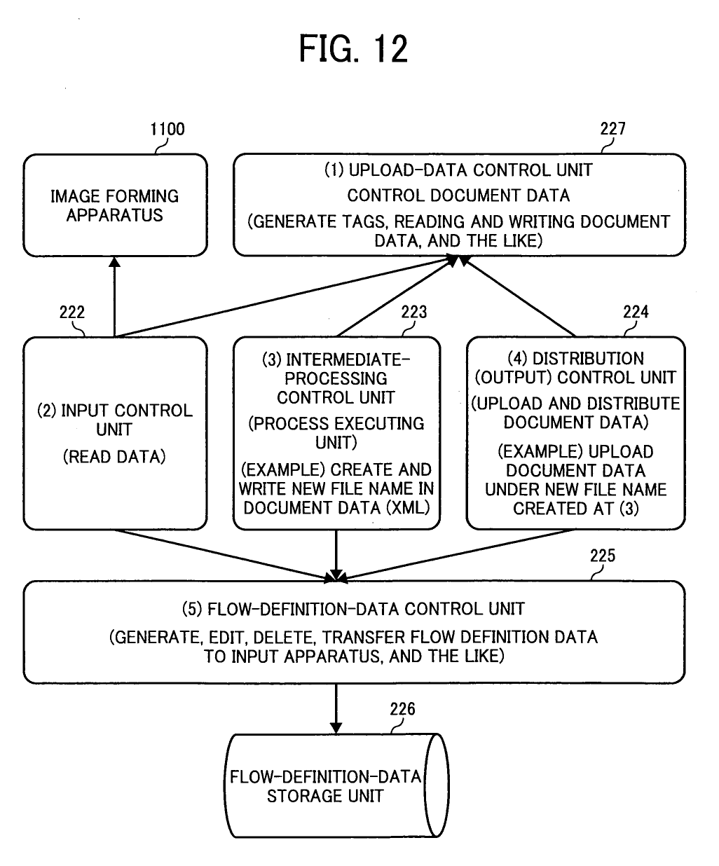

An example of the intermediate processing to be performed when “creating new folder” is defined as the upload mode in the flow definition data 206 will be described with reference to FIGS. 12 to 15. FIG. 12 is a schematic diagram depicting an exemplary module configuration for the “creating new folder” option. A scenario similar to that depicted in FIG. 8 through which image data is input to the flow definition apparatus 200 from the image forming apparatus 1100 and uploaded to the server apparatus 100 (flow name: “ScanToFolderanotherName”) applies to this option. The scenario involves the input control unit 222, the intermediate-processing control unit 223, the distribution (output) control unit 224, the flow-definition-data control unit 225, and the upload-data control unit 227 of the module configuration depicted in FIG. 12.

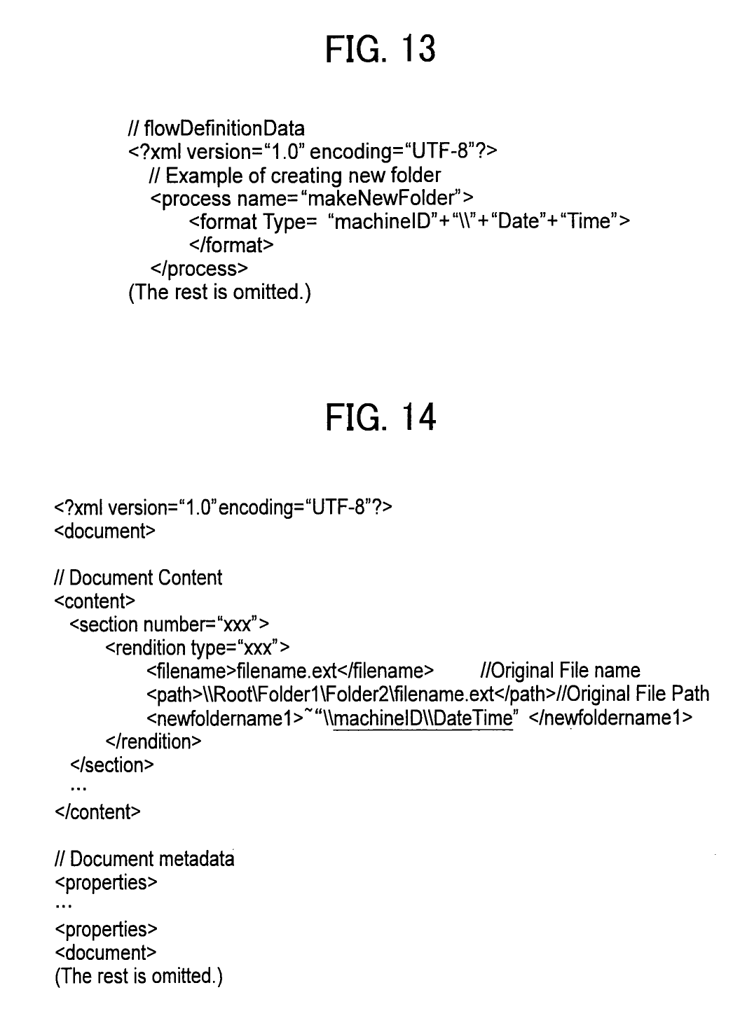

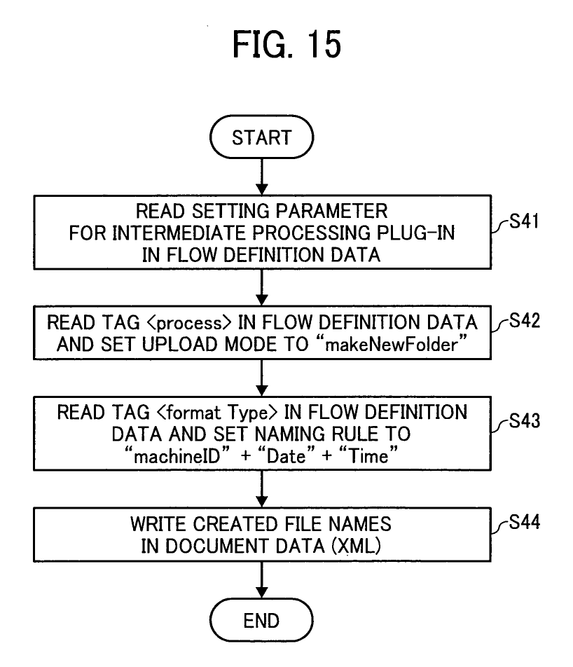

FIG. 13 is a part of an exemplary document data file (XML) in which the “creating new folder” option is defined as the upload mode. FIG. 14 is a part of an exemplary document data file (XML) that is created for the “creating new folder” option. FIG. 15 is a flowchart that illustrates an exemplary procedure for the “creating new folder” option. The flow-definition-data control unit 225 has control over the entire procedure.

As depicted in FIG. 15, the flow-definition-data control unit 225 reads a setting parameter for the intermediate processing plug-in from the flow definition data 206 (Step S41). As depicted in FIG. 14, when the “creating new folder” option is defined as the upload mode in the flow definition data 206, “makeNewFolder” is defined in the tag <process name>. Hence, (1) creation of a new folder is defined. In this upload mode, “machineID”+“¥¥”+“Date”+“Time” is defined in the tag <format Type>, thereby defining (2) naming rule: a machine ID followed by “¥¥”, which is a random number, the date, and the time.

The intermediate-processing control unit 223 takes out the tag <process> from the flow definition data 206 to acquire “makeNewFolder” as the upload mode, and recognizes that a new folder is to be created (Step S42).

The intermediate-processing control unit 223 takes out “machineID”+“¥¥”+“Date”+“Time” from the tag <format Type>, thereby creating a folder name “machineID”+“¥¥”+“Date”+“Time” (Step S43), and writes the folder name to the document data via the upload-data control unit 227 (Step S44).

For example, as depicted in FIG. 14, the new folder that is to be set by the distribution (output) control unit 224 is set in the document data. The portion of the file name indicated by “filename” is replaced with its original file name by the distribution (output) control unit 224.

The flow definition apparatus 200 according to Example 1 defines, when image data is to be uploaded to a desired folder in the server apparatus 100, an upload mode is defined to protect a same-name file from unintentionally being overwritten. A setting parameter for the upload mode is written in the flow definition data 206. Processing is performed such that a new file name or a new folder is automatically created based on a ruling name according to the upload mode defined in the flow definition data 206. Hence, data lost resulting from unintended file overwriting can be prevented. This technique also facilitates selection of an upload mode depending on a function of a target apparatus to which data is uploaded.

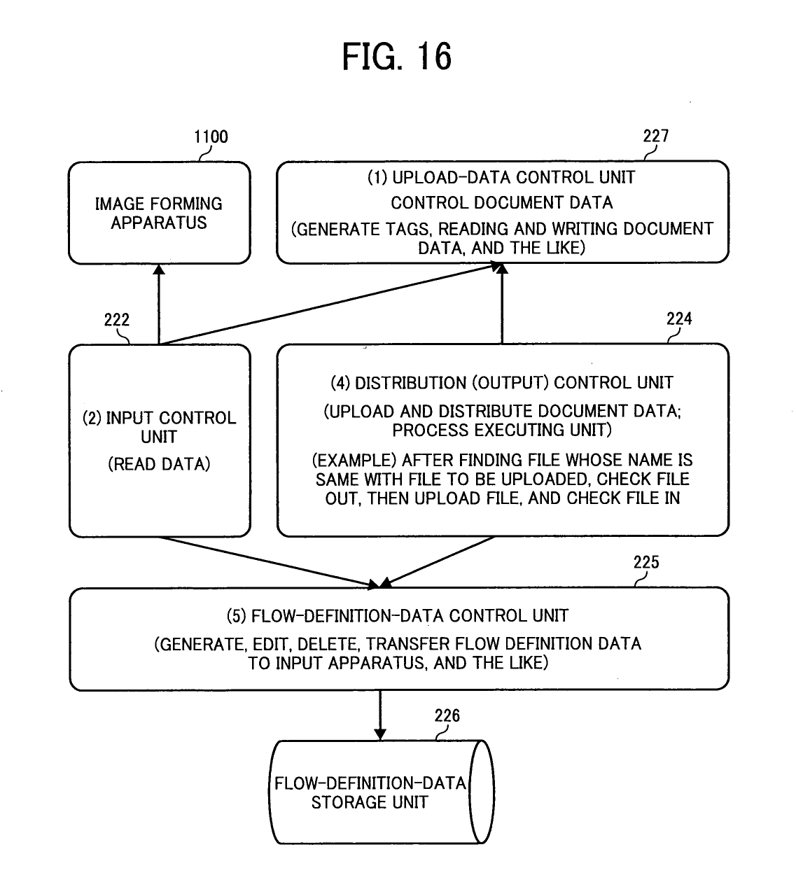

Exemplary processing according to Example 2 to which the present embodiment is applied will be described with reference to FIGS. 16 to 19. In the processing of Example 2, image data is input to the flow definition apparatus 200 from the image forming apparatus 1100, such as a scanner, and uploaded to a database in the server apparatus 100 or the like. A scenario of the generation of the flow definition data 206 in the processing of Example 2 is similar to that depicted in FIG. 4 while a similar scenario to that depicted in FIG. 8 through which image data that is input from the image forming apparatus 1100 is uploaded is applied to the processing of Example 2.

Generation of the flow definition data 206 according to Example 2 will be described with reference to FIG. 5. The scenario of the generation of the flow definition data involves the UI control unit 221, the input control unit 222, the distribution (output) control unit 224, and the flow-definition-data control unit 225 of the module configuration depicted in FIG. 3.

The UI control unit 221 controls the UI unit 220 to prompt an operator to enter setting-related information to create a scenario “ScanToDBAutoCheck-in”.

The UI control unit 221 acquires the setting-related information, such as a reading-related parameter, pertaining to the image forming apparatus 1100 from the input control unit 222, and transmits the setting-related information entered by the operator to the input control unit 222.

When the setting-related information fed from the UI control unit 221 contains a setting parameter to be processed by the input control unit 222 (Yes at Step S11), the input control unit 222 writes the setting parameter pertaining to the image forming apparatus 1100, such as the reading-related parameter, in the flow definition data 206 via the flow-definition-data control unit 225 (Step S12).

The UI control unit 221 displays the upload-mode input screen to prompt an operator to enter a setting parameter for an upload mode.

When the setting-related information contains a setting parameter related to the upload mode (in Example 2, “check-out & check-in” (automatic version upgrade)), the UI control unit 221 transmits the setting parameter to the distribution (output) control unit 224. Upon receipt of the setting parameter, the distribution (output) control unit 224 writes the setting parameter in the flow definition data 206 via the flow-definition-data control unit 225.

The UI control unit 221 then displays the upload-mode input screen to prompt an operator to enter setting data for the upload mode based on the setting parameter fed from the distribution (output) control unit 224. Examples of the setting data include a URL or data about a folder to which the data file is to be uploaded. The UI control unit 221 transmits the setting data entered by the operator to the distribution (output) control unit 224.

When the setting-related information contains a setting parameter to be processed by the distribution (output) control unit 224 (Yes at Step S15), the distribution (output) control unit 224 writes the setting parameter in the flow definition data 206 via the flow-definition-data control unit 225 (Step S16).

In each case where the input processing is not to be performed (No at Step S11), where the intermediate processing is not to be performed (No at Step S13), and where the distribution processing is not to be performed (No at Step S15), the system control proceeds to a corresponding subsequent step. In the processing of Example 2, the flow definition data 206 is generated in this manner, for example.

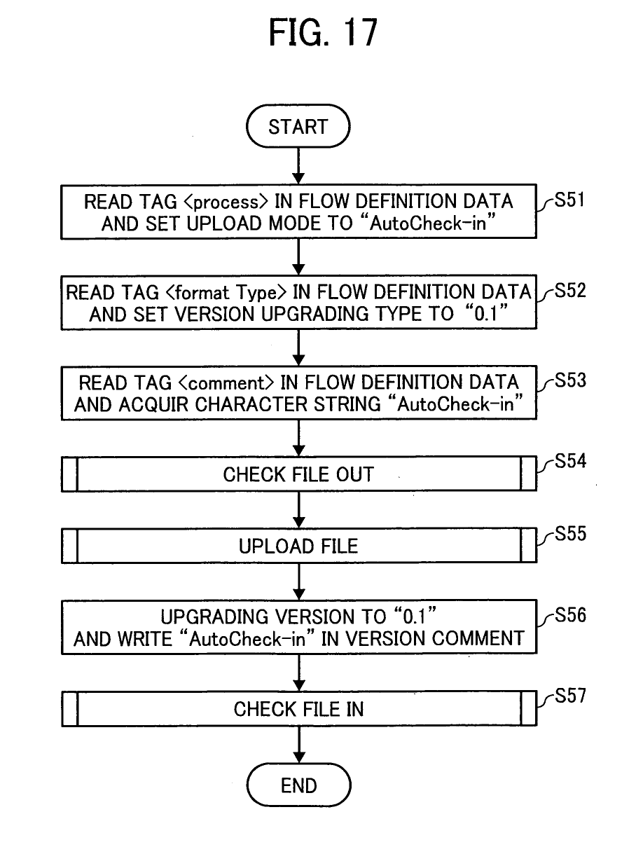

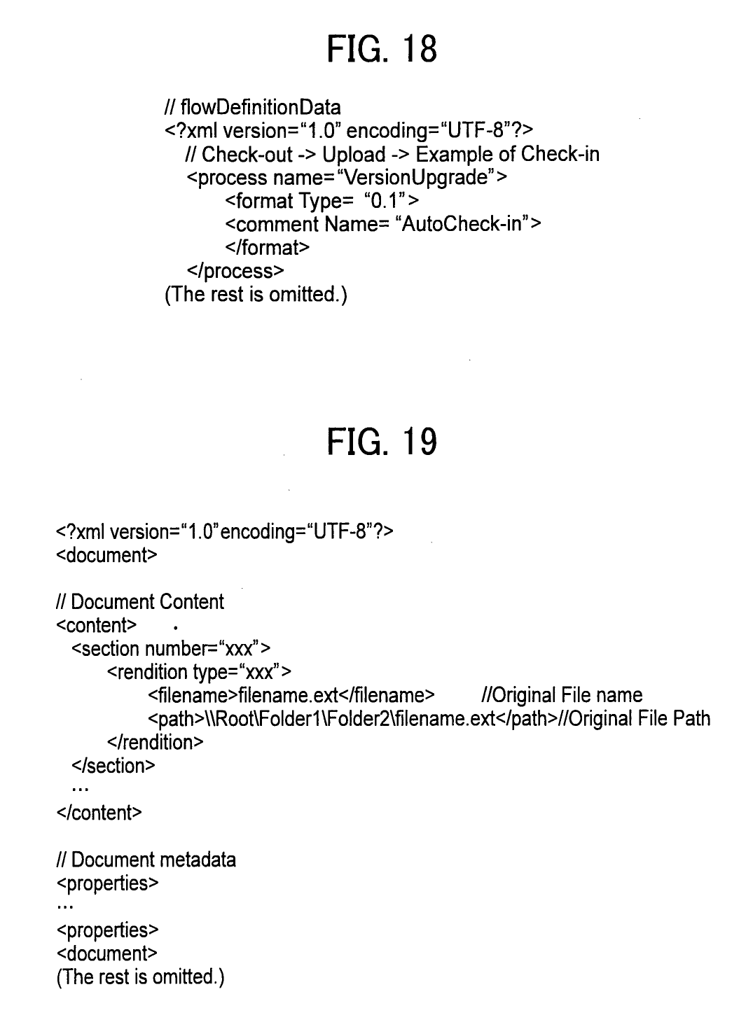

An exemplary processing of flow execution control to be performed when the “check-out & check-in” option is defined as the upload mode in the flow definition data 206 will be described with reference to FIGS. 16 to 19. FIG. 16 is an exemplary flow definition data file (XML) in which the “check-out & check-in” is defined as the upload mode. FIG. 17 is a flowchart that illustrates an exemplary procedure for the “check-out & check-in” option. FIG. 18 is a part of an exemplary document data file (XML) for the “check-out & check-in” option. FIG. 19 is a part of an exemplary document data file (XML) for the “check-out & check-in” option. The flow-definition-data control unit 226 has control over the entire procedure.

The flow-definition-data control unit 225 reads flow definition data 206. As depicted in FIG. 18, when the “check-out & check-in” option is defined as the upload mode in the flow definition data 206, “VersionUpgrade” is defined in the tag <process name>. As depicted in FIG. 19, in the processing of Example 2, version upgrading is performed. Accordingly, even when a same-name file has already been stored in the server apparatus 100, the image data is uploaded under its original file name and its original file path.

As depicted in FIG. 17, the distribution (output) control unit 224 takes out the tag <process> from the flow definition data 206 to acquire “VersionUpgrade”, and recognizes that the “check-out & check-in” option is defined as the upload mode (Step S51).

The distribution (output) control unit 224 reads “0.1” from the tag <format Type> (Step S52) and “AutoCheck-in” from the <comment Name> (Step S53), and causes the data file and/or the same-name file to be checked out (Step S54).

After the data file has been uploaded (Step S55), the distribution (output) control unit 224 sets a version number to “0.1” and writes “AutoCheck-in” in a version comment, respectively (Step S56), and causes the data file and/or the same-name file to be checked in (Step S57).

In this manner, the flow definition apparatus 200 according to Example 2 performs version control by causing the server apparatus 100 to check the data file and/or the same-name file out and in, thereby protecting the same-name file from being unintentionally overwritten. Put another way, the flow definition apparatus 200 performs automatic version upgrading, thereby avoiding data lost due to unintended overwriting of the same-name file.

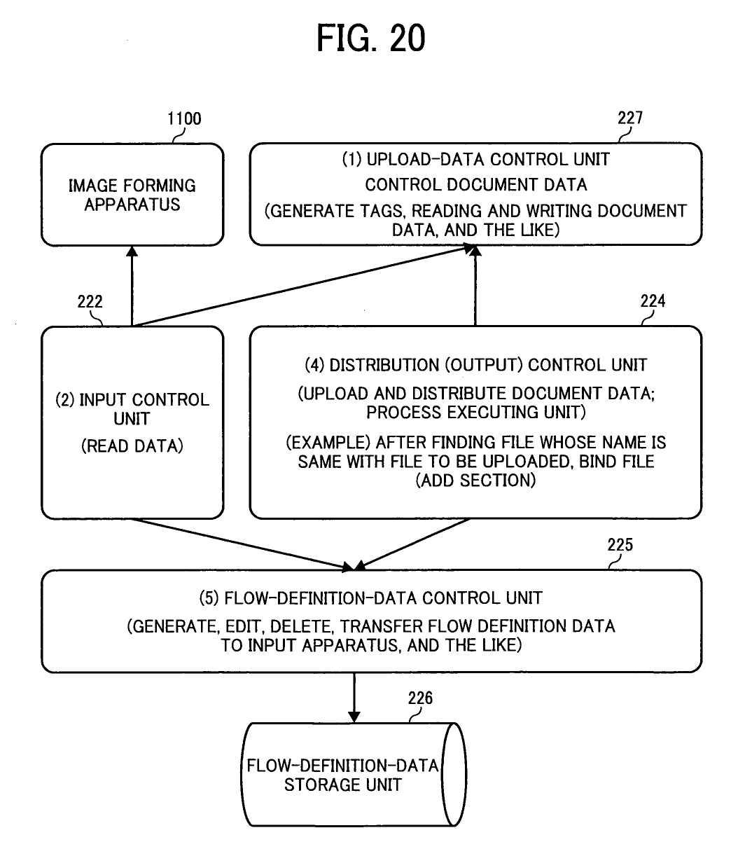

Exemplary processing according to Example 3 to which the present embodiment is applied will be described with reference to FIGS. 20 to 22. In the processing of Example 3, data is acquired, for example, by using a facsimile function, is bound on a document-by-document basis and then uploaded to a database. A scenario of the generation of the flow definition data 206 in the processing of Example 3 is similar to that depicted in FIG. 4 while a similar scenario to that depicted in FIG. 8 through which image data is input to the flow definition apparatus 200 from the image forming apparatus 1100 and then uploaded to the server apparatus 100 is applied to the processing.

Generation of the flow definition data 206 according to the processing of Example 3 will be described with reference to FIG. 5. The scenario of the generation of the flow definition data involves the UI control unit 221, the input control unit 222, the distribution (output) control unit 224, and the flow-definition-data control unit 225 of the module configuration depicted in FIG. 3.

As depicted in FIG. 3, the UI control unit 221 controls the UI unit 220 to prompt an operator to enter setting-related information to create a scenario “FaxToDBBind”.

The UI control unit 221 acquires the setting-related information, such as a reading-related parameter, pertaining to the image forming apparatus 1100 from the input control unit 222, and transmits the setting-related information entered by the operator to the input control unit 222.

The UI control unit 221 receives the setting-related information, such as the reading-related parameter, pertaining to the image forming apparatus 1100 from the UI control unit 221 and writes the setting parameter in the flow definition data 206 via the flow-definition-data control unit 225 (Step S12).

The UI control unit 221 displays the upload-mode input screen to prompt the operator to enter a setting parameter for an upload mode.

When the setting-related information contains a setting parameter for the upload mode (in Example 3, “bind”), the UI control unit 221 transmits the setting parameter to the distribution (output) control unit 224. Upon receipt of the setting parameter, the distribution (output) control unit 224 writes the setting parameter in the flow definition data 206 via the flow-definition-data control unit 225.

The UI control unit 221 displays the upload-mode input screen to prompt the operator to enter setting data related to the upload mode based on the setting parameter fed from the distribution (output) control unit 224. Examples of the setting parameter include a URL or data about a folder to which the image data is to be uploaded. The UI control unit 221 transmits the setting data entered by the operator to the distribution (output) control unit 224.

When the setting-related information contains a setting parameter to be processed by the distribution (output) control unit 224 (Yes at Step S15), the distribution (output) control unit 224 writes the setting parameter in the flow definition data 206 via the flow-definition-data control unit 225 (Step S16).

In each case where the input processing is not to be performed (No at Step S11), where the intermediate processing is not to be performed (No at Step S13), and where the distribution processing is not to be performed (No at Step S15), the system control proceeds to a corresponding subsequent step. In the processing of Example 3, the flow definition data 206 is generated in this manner, for example.

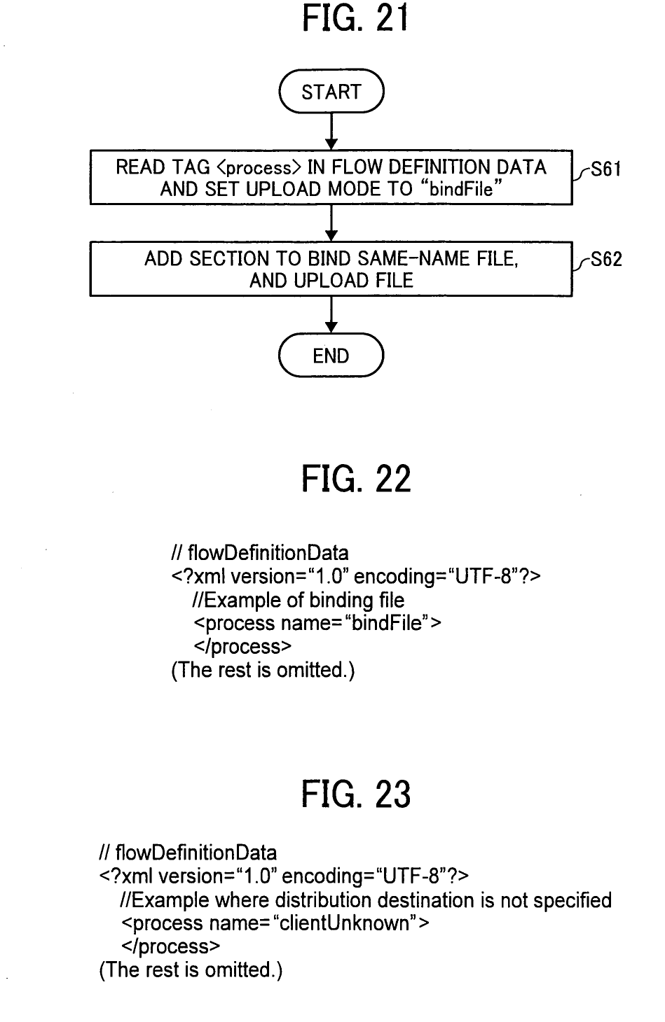

An example of flow execution control to be performed when the “bind” option is defined as the upload mode in the flow definition data 206 will be described with reference to FIGS. 20 to 22. FIG. 20 is a part of an exemplary module configuration for the “bind” option defined for the upload mode. FIG. 21 is a flowchart that illustrates an exemplary procedure for the “bind” option. FIG. 22 is a part of an exemplary document data file (XML) in which the “bind” option is defined. The flow-definition-data control unit 226 has control over the entire procedure.

As depicted in FIG. 21, the flow-definition-data control unit 225 reads the flow definition data 206. As depicted in FIG. 22, when the “bind” option is defined as the upload mode in the flow definition data 206, “bindFile” is defined in the tag <process name>.

The distribution (output) control unit 224 takes out the tag <process> from the flow definition data 206 to acquire “bindFile”, and recognizes that the “bind” option is defined as the upload mode (Step S61). The distribution (output) control unit 224 adds a section, binds the image data and the same-name file, and then uploads the data file (Step S62).

In this manner, the flow definition apparatus 200 according to Example 3 binds the image data and the same-name file, thereby protecting the same-name file from being unintentionally overwritten. Put another way, by performing binding automatically, data lost that can result from overwriting of the same-name file can be prevented.

Exemplary processing according to Example 4 to which the present embodiment is applied will be described with reference to FIGS. 23 to 25. In the processing of Example 4, image data fed from the image forming apparatus 1100 is uploaded to a document management apparatus. A scenario of the generation of the flow definition data 206 of the processing of Example 4 is similar to that depicted in FIG. 4 while a similar scenario to that depicted in FIG. 8 through which image data is input to the flow definition apparatus 200 from the image forming apparatus 1100 and uploaded to the server apparatus 100 is applied to the processing.

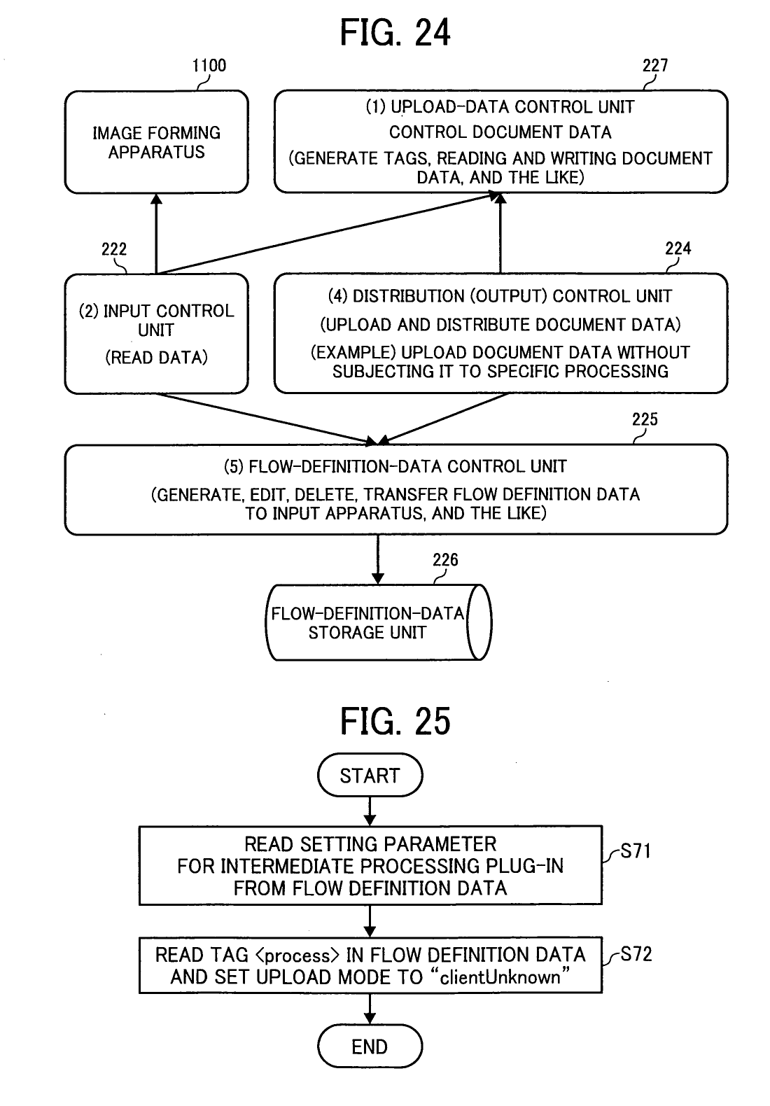

FIG. 23 is a part of an exemplary document data file (XML) in which an option where distribution destination to which a target file to be uploaded is not specified (hereinafter, “destination-not-specified”) is defined. FIG. 24 is a schematic diagram depicting an exemplary module configuration for the destination-not-specified option. FIG. 25 is a flowchart that illustrates an exemplary procedure for the destination-not-specified option. The flow-definition-data control unit 225 has control over the entire procedure.

As depicted in FIG. 25, the flow-definition-data control unit 225 reads the flow definition data 206 (Step S71). As depicted in FIG. 23, the destination-not-specified option is defined and written by the module depicted in FIG. 24 as the upload mode in the flow definition data 206, and “clientUnknown” is defined in the tag <process name>.

The distribution (output) control unit 224 takes out the tag <process> from the flow definition data 206 to acquire “clientUnknown”, recognizes that the destination-not-specified option is defined as the upload mode, and upload the data file in a usual manner (Step S72).

According to Example 4, when a data file is to be uploaded to a server, such as the server apparatus 100, that contains a same-name file and if the server apparatus 100 has a function of protecting the same-name file from being overwritten, the flow definition apparatus 200 performs processing depending on the function. This makes it possible to automate uploading by effectively utilizing the function of the server apparatus 100, thereby preventing data lost that can result from unintended overwriting of the same-name file.

The flow definition apparatus 200, the image forming apparatus 1100, and the server apparatus 100 according to Examples 1 to 4 of the embodiment has hardware configuration that utilizes a typical computer and includes, as required, a control device such as a central processing unit (CPU), a storage device such as a read only memory (ROM) and/or a random access memory (RAM), an external storage device such as an HDD and/or a compact disk (CD) drive, a display device, and an input device such as a keyboard and/or a mouse.

Computer programs to be executed by the flow definition apparatus 200 and the image forming apparatus 1100 according to Examples 1 to 4 of the embodiment can be provided by being recorded in a computer-readable recording medium, such as a compact disk read only memory (CD-ROM), a flexible disk (FD), a compact disk recordable (CD-R), a digital versatile disk (DVD), or the like, as a file in an installable format or an executable format.

The computer programs to be executed by the flow definition apparatus 200 and the image forming apparatus 1100 according to the embodiment can be stored in a computer connected to a network such as the Internet so that the computer program can be downloaded via the network. The computer programs to be executed by the flow definition apparatus 200 and the image forming apparatus 1100 according to the embodiment can be can be provided or distributed via the network such as the Internet. The computer programs can be provided by being installed in a ROM or the like in advance.

The computer programs to be executed by the flow definition apparatus 200 and the image forming apparatus 1100 according to the embodiment have the module configuration made of the above-mentioned units (the remote communication unit, the flow-execution control unit, the flow-definition generating unit, and the screen-definition generating unit). As actual hardware, the CPU can read the computer programs from the recording medium and execute them to load the units on main memory, thereby generating the remote communication unit, the flow-execution control unit, the flow-definition generating unit, and the screen-definition generating unit on the main memory.

The computer programs for processing the distribution to be executed by the image forming apparatus 1100 according to Examples 1 to 4 the embodiment can be provided by recording them in a computer-readable recording medium such as a CD-ROM, an FD, a CD-R, a DVD, or the like as a file in an installable format or an executable format.

The computer programs to be executed by the image forming apparatus 1100 according to the embodiment can be stored in a computer connected to a network such as the Internet so that the computer program is provided by downloading via the network. The computer programs to be executed by the image forming apparatus 1100 according to Examples 1 to 4 can be provided or distributed via a network such as the Internet.

The computer programs to be executed by the image forming apparatus 1100 according to the embodiment have the module configuration made of the above-mentioned units (the scanner application software, the printer application software, the control unit, the remote communication unit, the display control unit, the processing unit, the flow-execution control unit, the flow-definition generating unit, and the screen-definition generating unit). As actual hardware, the CPU can read the distributed computer program from the ROM and execute them to load the units on main memory, thereby generating the scanner application software, the printer application software, the control unit, the remote communication unit, the display control unit, the processing unit, the flow-execution control unit, the flow-definition generating unit, and the screen-definition generating unit on the main memory.

It has been mentioned that the flow definition apparatus and the image forming apparatus are provided in different enclosures that are independent from each other. However, the present invention is not limited to such a configuration, and a part or all of the units of the flow definition apparatus can be provided in the image forming apparatus. It has been mentioned that the flow definition apparatus and the image forming apparatus are connected with each other via a network such as LAN or the Internet; however, the flow definition apparatus and the image forming apparatus can be connected directly with each other. It has been mentioned that the flow definition apparatus, the image forming apparatus, and the server apparatus are provided in different enclosures separate from one another (see FIG. 1). However, these apparatuses can be provided in a single enclosure by implementing the flow definition apparatus as a control unit, the image forming apparatus as an input unit, and the server apparatus as a database and connecting these units with a bus or the like with one another. It has been mentioned that the server apparatus is an independent external apparatus; however, any one of distribution (information management) apparatus (the flow definition apparatus 200 or the like), a PC, and the like can also serve as the server apparatus.

For example, the present invention can be applied as an output (distribution) plug-in to output (distribute) data to a Microsoft(trademark) SharePoint Server(trademark). More specifically, the present invention can be used as an interface between a SharePoint Server and a Web Service(trademark) that protects, when a data file is to be uploaded to the SharePoint Server, a same-name file from being overwritten.

According to the process control method of the present embodiment, the flow-definition-data controlling includes the flow-definition-data control unit defining the upload mode in which a new file name is created for the file of the identical name to avoid the data overwrite.

Furthermore, according to the process control method of the present embodiment, the flow-definition-data controlling includes the flow-definition-data control unit defining the upload mode in which the new file name is created by at least one of attaching a parenthesized number to a file name of the file of the identical name, using either one of an account of a user and an identification of the user, using a date and time when the data is processed by the data input apparatus, and generating a random number.

Moreover, according to the process control method of the present embodiment, the flow-definition-data controlling includes the flow-definition-data control unit defining the upload mode in which a new folder is created at an upload destination in the arbitrary apparatus so that the data is uploaded into the new folder to avoid the data overwrite.

Furthermore, according to the process control method of the present embodiment, the flow-definition-data controlling includes the flow-definition-data control unit defining the upload mode in which a folder name of the new folder is created by at least one of using either one of an account of a user and an identification of the user, using a date and time when the data is processed by the data input apparatus, and using an identification of the data input apparatus.

Moreover, according to the process control method of the present embodiment, the flow-definition-data controlling includes the flow-definition-data control unit defining the upload mode in which a version control is performed by causing the arbitrary apparatus checks out or checks in at least one of the data and the file to avoid the data overwrite.

Furthermore, according to the process control method of the present embodiment, the flow-definition-data controlling includes the flow-definition-data control unit defining the upload mode in which a binding of the data and the file is performed to avoid the data overwrite.

Moreover, according to the process control method of the present embodiment, the flow-definition-data controlling includes the flow-definition-data control unit defining the upload mode in which the binding of the data and the file is performed by adding a section to the file.

Furthermore, according to the process control method of the present embodiment, when the arbitrary apparatus includes an overwrite avoiding unit to avoid the data overwrite, the flow-execution controlling includes the flow-execution control unit controlling the execution of the at least one process according to the overwrite avoiding unit.

Moreover, according to the process control method of the present embodiment, the data input apparatus is an image forming apparatus that is capable of inputting image data as the data.

Furthermore, according to the process control method of the present embodiment, the information processing apparatus further comprising a second storage unit that stores therein screen definition data defining an upload-mode input screen that displays the upload mode in an inputtable manner. Upon executing the at least one process, the communicating includes the communication unit transmitting the screen definition data to the data input apparatus and receiving the upload mode input from the upload-mode input screen displayed on the data input apparatus based on the screen definition data. The flow-definition-data controlling includes the flow-definition-data control unit setting the upload mode.

Moreover, according to the computer program product of the present embodiment, the flow-definition-data controlling includes the flow-definition-data control unit defining the upload mode in which a new file name is created for the file of the identical name to avoid the data overwrite.

Furthermore, according to the computer program product of the present embodiment, the flow-definition-data controlling includes the flow-definition-data control unit defining the upload mode in which the new file name is created by at least one of attaching a parenthesized number to a file name of the file of the identical name, using either one of an account of a user and an identification of the user, using a date and time when the data is processed by the data input apparatus, and generating a random number.

Moreover, according to the computer program product of the present embodiment, the flow-definition-data controlling includes the flow-definition-data control unit defining the upload mode in which a new folder is created at an upload destination in the arbitrary apparatus so that the data is uploaded into the new folder to avoid the data overwrite.

Furthermore, according to the computer program product of the present embodiment, the flow-definition-data controlling includes the flow-definition-data control unit defining the upload mode in which a folder name of the new folder is created by at least one of using either one of an account of a user and an identification of the user, using a date and time when the data is processed by the data input apparatus, and using an identification of the data input apparatus.

Moreover, according to the computer program product of the present embodiment, the flow-definition-data controlling includes the flow-definition-data control unit defining the upload mode in which a version control is performed by causing the arbitrary apparatus checks out or checks in at least one of the data and the file to avoid the data overwrite.

Furthermore, according to the computer program product of the present embodiment, the flow-definition-data controlling includes the flow-definition-data control unit defining the upload mode in which a binding of the data and the file is performed to avoid the data overwrite.

Moreover, according to the computer program product of the present embodiment, the flow-definition-data controlling includes the flow-definition-data control unit defining the upload mode in which the binding of the data and the file is performed by adding a section to the file.

Furthermore, according to the computer program product of the present embodiment, when the arbitrary apparatus includes an overwrite avoiding unit to avoid the data overwrite, the flow-execution controlling includes the flow-execution control unit controlling the execution of the at least one process according to the overwrite avoiding unit.

Moreover, according to the computer program product of the present embodiment, the data input apparatus is an image forming apparatus that is capable of inputting image data as the data.

Furthermore, according to the computer program product of the present embodiment, the information processing apparatus further comprising a second storage unit that stores therein screen definition data defining an upload-mode input screen that displays the upload mode in an inputtable manner. Upon executing the at least one process, the communicating includes the communication unit transmitting the screen definition data to the data input apparatus and receiving the upload mode input from the upload-mode input screen displayed on the data input apparatus based on the screen definition data. The flow-definition-data controlling includes the flow-definition-data control unit setting the upload mode.

The present invention is not limited to the embodiments, and can be modified in various manners without departing from the scope of the invention. Different elements disclosed in the embodiments can be combined appropriately. For example, some elements can be omitted from the elements described in embodiments. Elements in different embodiments may be combined appropriately.

According to one aspect of the present invention, when a data file fed from a data input apparatus is to be uploaded to a target apparatus, such as a server apparatus, a same-name file of which file name is the same with a file name of the data file and which has already been stored in the apparatus is protected from unintentionally overwritten. Accordingly, data lost resulting from overwriting the same-name file can be advantageously prevented.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information processing apparatus comprising:
a storage unit that is connected to a network and stores therein flow definition data defining process flow of at least one process for data input from a data input apparatus;
a communication unit that controls transmission and reception of data between the data input apparatus and an arbitrary apparatus that is connected to the network;
a flow-execution control unit that controls execution of the at least one process for the data based on the flow definition data; and
a flow-definition-data control unit that defines an upload mode for avoiding a data overwrite when a file of an identical name exists in the arbitrary apparatus upon uploading the data to the arbitrary apparatus, sets the upload mode in the flow definition data, and stores the
flow definition data in the storage unit, wherein when the file of the identical name exists in the arbitrary apparatus, the flow-execution control unit performs the at least one process according to the upload mode set in the flow definition data.

2. The information processing apparatus according to claim 1, wherein the flow-definition-data control unit defines the upload mode in which a new file name is created for the file of the identical name to avoid the data overwrite.

3. The information processing apparatus according to claim 2, wherein the flow-definition-data control unit defines the upload mode in which the new file name is created by at least one of attaching a parenthesized number to a file name of the file of the identical name, using either one of an account of a user and an identification of the user, using a date and time when the data is processed by the data input apparatus, and generating a random number.

4. The information processing apparatus according to claim 1, wherein the flow-definition-data control unit defines the upload mode in which a new folder is created at an upload destination in the arbitrary apparatus so that the data is uploaded into the new folder to avoid the data overwrite.

5. The information processing apparatus according to claim 4, wherein the flow-definition-data control unit defines the upload mode in which a folder name of the new folder is created by at least one of using either one of an account of a user and an identification of the user, using a date and time when the data is processed by the data input apparatus, and using an identification of the data input apparatus.

6. The information processing apparatus according to claim 1, wherein the flow-definition-data control unit defines the upload mode in which a version control is performed by causing the arbitrary apparatus checks out or checks in at least one of the data and the file to avoid the data overwrite.

7. The information processing apparatus according to claim 1, wherein the flow-definition-data control unit defines the upload mode in which a binding of the data and the file is performed to avoid the data overwrite.

8. The information processing apparatus according to claim 7, wherein the flow-definition-data control unit defines the upload mode in which the binding of the data and the file is performed by adding a section to the file.

9. The information processing apparatus according to claim 1, wherein when the arbitrary apparatus includes an overwrite avoiding unit to avoid the data overwrite, the flow-execution control unit controls the execution of the at least one process according to the overwrite avoiding unit.

10. The information processing apparatus according to claim 1, wherein the data input apparatus is an image forming apparatus that is capable of inputting image data as the data.

11. The information processing apparatus according to claim 1, further comprising a second storage unit that stores therein screen definition data defining an upload-mode input screen that displays the upload mode in an inputtable manner, wherein
upon executing the at least one process, the communication unit transmits the screen definition data to the data input apparatus and receives the upload mode input from the upload-mode input screen displayed on the data input apparatus based on the screen definition data, and
the flow-definition-data control unit sets the upload mode.

12. A method of controlling a process executed in an information processing apparatus that is connected to a data input apparatus and an arbitrary apparatus via a network, the information processing apparatus including a storage unit that stores therein flow definition data defining process flow of at least one process for data input from the data input apparatus, the method comprising:
communicating including a communication unit controlling transmission and reception of data between the data input apparatus and the arbitrary apparatus;
flow-execution controlling including a flow-execution control unit controlling execution of the at least one process for the data based on the flow definition data; and
flow-definition-data controlling including a flow-definition-data control unit defining an upload mode for avoiding a data overwrite when a file of an identical name exists in the arbitrary apparatus upon uploading the data to the arbitrary apparatus, setting the upload mode in the flow definition data, and storing the flow definition data in the storage unit, wherein
when the file of the identical name exists in the arbitrary apparatus, the flow-execution controlling includes the flow-execution control unit performing the at least one process according to the upload mode set in the flow definition data.

13. A computer program product comprising a computer-usable medium having computer-readable program codes embodied in the medium for controlling a process executed in an information processing apparatus that is connected to a data input apparatus and an arbitrary apparatus via a network, the information processing apparatus including a storage unit that stores therein flow definition data defining process flow of at least one process for data input from the data input apparatus, the program codes when executed causing a computer to executed:
communicating including a communication unit controlling transmission and reception of data between the data input apparatus and the arbitrary apparatus;
flow-execution controlling including a flow-execution control unit controlling execution of the at least one process for the data based on the flow definition data; and
flow-definition-data controlling including a flow-definition-data control unit defining an upload mode for avoiding a data overwrite when a file of an identical name exists in the arbitrary apparatus upon uploading the data to the arbitrary apparatus, setting the upload mode in the flow definition data, and storing the flow definition data in the storage unit, wherein
when the file of the identical name exists in the arbitrary apparatus, the flow-execution controlling includes the flow-execution control unit performing the at least one process according to the upload mode set in the flow definition data.
